(19) United States
(12) Patent Application Publication
(10) Pub. No.: US 2009/0083531 A1
(43) Pub. Date: Mar. 26, 2009

(54) System and method for modifying software routines

(76) Inventors: Ting Nmi Zhou, Kokomo, IN (US); Randall T. Brunts, Carmel, IN (US); David C. Anthony, Kokomo, IN (US); Gerry A. Vanhorn, Dayton, IN (US); Julanne L. Dahlquist, Kokomo, IN (US); Robert B. Demoret, Kokomo, IN (US)

Correspondence Address: DELPHI TECHNOLOGIES, INC., M/C 480-410-202, PO BOX 5052, TROY, MI, 48007, US

(21) Appl. No.: 11/903,728

(22) Filed: Sep. 24, 2007

(51) Int. Cl. G06F 15/177

(52) U.S. Cl. 713/1

(57) ABSTRACT

A system and method for modifying software routines is provided. The system includes a computer device and a hardware device. The hardware device is in communication with the computer device, and includes a memory device that stores at least one of an initialized software routine and a non-initialized software routine, and a processor executes the at least one initialized software routine. At least one of the initialized and non-initialized software routines are modified by the steps including generating an authorization code by the computer device, wherein the authorization code is unique to the hardware device, loading the authorization code, and authenticating the authorization code. The modification steps further include creating a current software enable matrix, communicating the current software enable matrix, overwriting a previous software enable matrix with the current software enable matrix, and modifying at least one software routine.

### TECHNICAL FIELD

The present invention generally relates to a system and method for implementing software routines, and more particularly, to a system and method for implementing software routines to control a hardware device having at least one operable feature.

### BACKGROUND OF THE DISCLOSURE

Generally, hardware devices frequently include microprocessor, which execute software routines in order for the hardware device to function as desired. Typically, the software routine is embedded in the hardware device at the time the hardware device is sold in order for the user of the hardware device to use the hardware device for its intended purpose. Thus, the hardware device and software are typically sold as a complete package, such that the entire software package must be developed at the time the hardware device is sold.

Generally, a hardware device can be used for multiple functions or purposes, and one user may not utilize all of the available functions offered by the hardware device. Thus, a portion of the functions of the hardware device, or software routines, may be unused, but the purchaser typically pays for all the functions due to the hardware device and software being sold as a complete package. One possible result could be that a potential user of the hardware device may be deterred from purchasing the hardware device when the user is required to purchase all of the available functions of the hardware device where they will most likely not use a portion of such functions.

### SUMMARY OF THE INVENTION

According to one aspect of the present invention, a system for implementing software routines includes a computer device and a hardware device. The computer device accesses an authorization database. The hardware device is in communication with the computer device, wherein the hardware device includes a memory device that stores at least one of an initialized software routine and a non-initialized software routine, and a processor executes the at least one initialized software routine. At least one of the initialized and non-initialized software routines are modified by the steps including generating an authorization code by the computer device, wherein the authorization code is unique to the hardware device and loading the authorization code. The modification steps further include authenticating the authorization code, communicating the software enable matrix from the computer device to the hardware device, creating a current software enable matrix based upon at least the authorization code, overwriting a previous software enable matrix with the current software enable matrix, and modifying at least one of the initialized and non-initialized software routines based upon the current software enable matrix, such that at least one of the initialized software routine is modified to be non-initialized and the non-initialized software routine is initialized.

According to another aspect of the present invention, a method of modifying software routines executed by a hardware device, includes the steps of generating an authorization code, wherein the authorization code is unique to the hardware device, encrypting the authorization code, and loading the authorization code. The method further includes the steps of authenticating the authorization code, decrypting the authorization code, creating a current software enable matrix based upon at least the authorization code, overwriting a previous software enable matrix with the current software enable matrix, and modifying at least one software routine based upon the current software enable matrix, such that at least one of an initialized software routine of the at least one software routine stored on the hardware device is modified to be non-initialized and a non-initialized software routine of the at least one software routine stored on said hardware device is initialized.

According to yet another aspect of the present invention, a method of modifying software routines executed by a hardware device includes the steps of generating an authorization code, wherein the authorization code is unique to the hardware device, such that the authorization code is based upon at least one of a purchase date of the hardware device, a purchased at least one operable feature, and an identification number relating to the hardware device, and decrypting the authorization code. The method further includes the steps of loading the authorization code, decrypting the authorization code, authenticating the authorization code by comparing data embedded in the authorization code to corresponding data on the hardware device, creating a current software enable matrix based upon at least the authorization code, overwriting a previous software enable matrix with the current software enable matrix, and modifying at least one software routine based upon the current software enable matrix, such that at least one of an initialized software routine of the at least one software routine stored on the hardware device is modified to be non-initialized and a non-initialized software routine of the at least one software routine stored on said hardware device is initialized.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of a system for implementing software routines in a hardware device, in accordance with one embodiment of the present invention;

FIG. 2 is a front perspective view of a housing enclosing a processor, in accordance with one embodiment of the present invention;

FIG. 3 is a flow chart illustrating a method of creating authorization code, in accordance with one embodiment of the present invention; and

FIG. 4 is a flow chart illustrating a method of implementing software routines in a hardware device, in accordance with one embodiment of the present invention.

### DESCRIPTION OF PREFERRED EMBODIMENTS

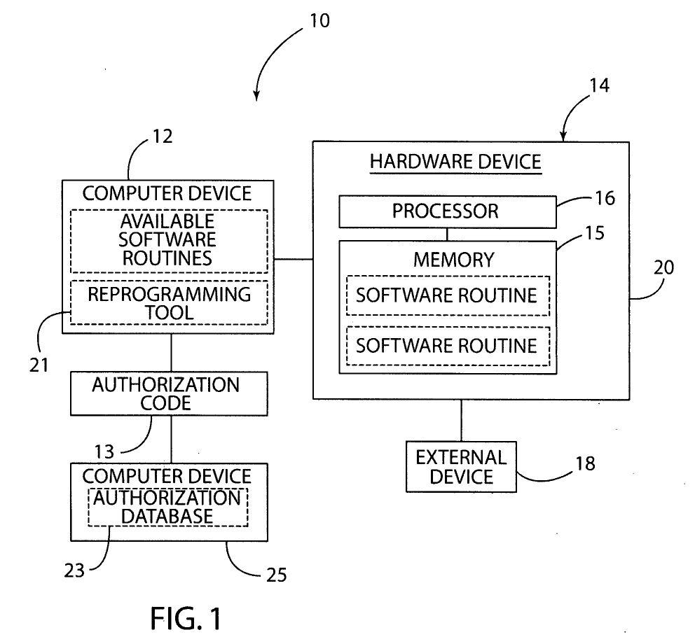

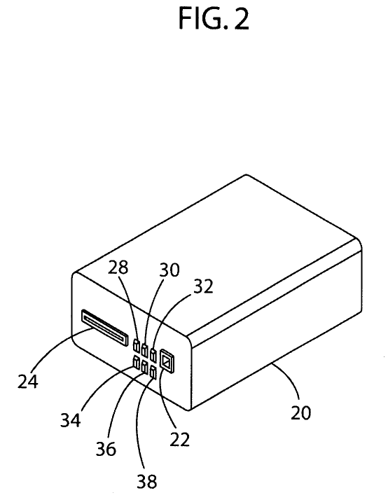

In reference to both FIGS. 1 and 2, a system for implementing software routines is generally shown at reference identifier 10. The system 10 includes a computer device 12 that has a reprogramming tool, and accesses available software routines and data, such as an authorization code 13, according to one embodiment. A hardware device generally indicated at 14 is in communication with the computer device 12. The hardware device 14 includes a memory device 15 and a processor 16. The memory device 15 stores initialized software routine(s) and non-initialized software routine(s). The processor 16 executes at least one initialized software routine, wherein the initialized software routine and non-initialized software routine are modified, as set forth in greater detail herein.

According to a disclosed embodiment, the hardware device 14 is used with an external device 18. By way of explanation and not limitation, the hardware device 14 is used with a vehicle controller, such as, but not limited to, an electronics control unit (ECU), according to one embodiment. The processor 16 executes at least one of the initialized software routines to communicate with the external device 18. Generally, an ECU can be used to control electrical systems, such as a sound system, an airbag deployment system, door locks, a restraint system, an occupant sensing module, or mechanical systems of the external device 18, such as, engine valves, brake system, or fuel systems, other systems on the external device 18, or a combination thereof. According to a disclosed embodiment, the hardware device 14 can obtain data about the operation or operating conditions of the external device 18, when the hardware device 14 is communicating with the external device 18. According to an alternate embodiment, the external device 18 is a “device under test” or a device being tested in a laboratory, such that the hardware device 14 can obtain data about the operation or operating conditions of the external device 18, when the hardware device 14 is communicating with the external device 18.

According to one embodiment, the processor 16 is enclosed within a housing 20 of the hardware device 14. The computer device 12 can be in communication with the hardware device 14 using a hard wire to connect the computer device 12 and hardware device 14, wherein the computer device 12 and hardware device 14 have serial ports 22 for connecting the hard wire, such as, but not limited to, a universal serial bus (USB) port, according to one embodiment. Additionally, data can be communicated to and from the computer device 12 and the hardware device 14 using a removable memory media device, such as, but not limited to, secure digital (SD) memory card that is inserted in the SD card slot 24 of the housing 20.

According to an alternate embodiment, the computer device 12 and hardware device 14 can be in wireless communication with one another, such that the computer device 12 includes a wireless transmitter, and the hardware device 14 includes a wireless receiver. Additionally, the computer device 12 can include a wireless receiver, and the hardware device 14 can include a wireless transmitter for communicating from the hardware device 14 to the computer device 12. It should be appreciated by those skilled in the art that other suitable formats of communication can be used to communicate data, such as the software routines and authorization codes, between the computer device 12 and hardware device 14.

The processor 16 typically is in communication with a memory device 15, according to one embodiment. Additionally or alternatively, the processor 16 includes a memory device. The memory device 15 can be any suitable memory device for storing the authorization code, the data for authenticating the authorization code, the software routines, other desirable data, or a combination thereof. Exemplary memory devices are, but not limited to, volatile memory devices, such as random access memory (RAM), or the like, or non-volatile memory devices, such as read-only memory (ROM), electrically erasable programmable read-only memory (EEPROM), flash memory, or the like. According to one embodiment, the memory device 15 can be enclosed within the housing 20 with the processor 16. According to a disclosed embodiment, the processor 16 can function as software or firmware loader by receiving the loaded data and processing the data, as described in greater detail herein.

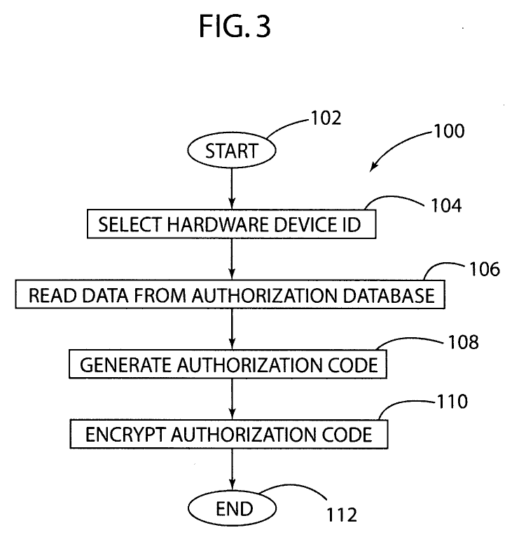

With regards to FIGS. 1-3, a method of creating an authorization code is generally shown in FIG. 3 at reference identifier 100. The method 100 starts at step 102, and proceeds to step 104, wherein an identification number is selected for the hardware device 14. For purposes of explanation and not limitation, the hardware device 14 identification can be a serial number, or the like. The method 100 then proceeds to step 106, wherein data is read from the authorization code 13. According to one embodiment, the authorization code 13 is at least a portion of the memory storage of the computer device 12, and contains data relating to the hardware device 14. According to an alternate embodiment, the authorization code 13 is external to the computer device 12.

At step 108, the authorization code is generated. According to one embodiment, the authorization code is based upon at least one of a purchase date of the hardware device 14, a list of one or more initialized software routines that were purchased, such as a name of the software routines, an identification number relating to the hardware device 14, the like, or a combination thereof. At step 110, the authorization code is encrypted, and the method 100 then ends at step 112.

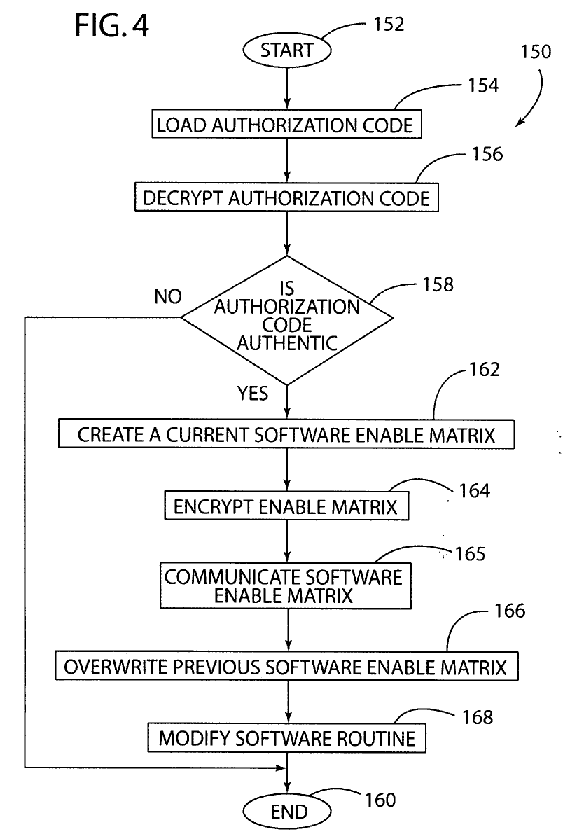

With regards to FIGS. 1-4, a method of modifying software routines executed by the hardware device 14 is generally shown in FIG. 4 at reference identifier 150. The method 150 starts at step 152, and proceeds to step 154, wherein an authorization code is loaded. According to one embodiment, the authorization code is created by accessing the authorization database 23, such that the authorization database 23 is external to the computer device 12. Thus, the authorization database 23 can be, but is not limited to, located on a second computer device 25, which can be a computer or server of the software routine supplier. According to an alternate embodiment, the computer device 12 accesses the authorization code 13 that is internal to the computer device 12.

Typically, the computer device 12 reads the authorization code 13 that corresponds to a specific hardware device 14, according to one embodiment. According to one embodiment, the computer device 12 can include a reprogramming tool 21, which has hardware circuitry and/or one or more software routines for decrypting the authorization code, obtain data from the authorization database and/or a database containing a list of the available software routines, communicate with the hardware device 14, the like, or a combination thereof. According to a disclosed embodiment, the authorization code is based upon at least one of a purchase data of the hardware device 14, one or more software routines, such as, but not limited to, at least one initialized software routine that was purchased, an identification number relating to the hardware device 14, the like, or a combination thereof. Thus, the authorization code can be unique to the hardware device 14. It should be appreciated by those skilled in the art that the authorization code can be based upon any desirable data, such that the authorization code is unique to the hardware device 14.

The method 150 then proceeds to step 156, wherein the authorization code is decrypted. At decision step 158, it is determined if the authorization code is authentic. According to one embodiment, the authentication of the authorization code is executed by the computer device 12 with data from hardware device 14 by comparing the data embedded in the authorization code to corresponding data stored in the memory device 15 of the hardware device 14. Thus, if the authorization code is based upon the purchase date of the hardware device 14 and purchase date of the software routines, or other data specific to the hardware device 14, the corresponding data stored in the memory of the hardware device 14 relates to identifying the hardware device 14. The unique data embedded in the authorization code can be compared by the data stored on the hardware device 14 in order to determine if the authorization code is authentic. According to a disclosed embodiment, the authorization code is an encoded binary authorization code. If it is determined at decision step 158 that the authorization code is not authentic, then the method 150 ends at step 160.

However, if it is determined at decision step 158 that the authorization code is authentic, then the method 150 proceeds to step 162, wherein a current software enable matrix is created based upon data embedded in the authorization code. Thus, the software enable matrix includes data relating to the initialized software routines of the hardware device 14 that have been purchased and are to be initialized. At step 164, the current software enable matrix is encrypted by the computer device 12, and combined with additional software to be communicated to the hardware device 14, according to one embodiment. Thus, the hardware device 14 can execute one or more initialized software routines by decrypting the encrypted software enable matrix, according to a disclosed embodiment.

The method 150 then proceeds to step 165, wherein the software enable matrix is communicated or downloaded from the computer device 12 to the hardware device 14. By way of explanation and not limitation, the software enable matrix can be communicated from the computer device 12 to the hardware device 14 by a hardwire connection, a wireless communication, a removable memory media device, such as, but not limited to, an SD memory card. At step 166, the encrypted enable matrix overwrites the previous software enable matrix, and at step 168, the software routine is modified. Thus, initialized software routines can be modified to be non-initialized, non-initialized software routines can be modified to be initialized, additional software routines can be loaded onto the hardware device 14 that are either initialized or non-initialized, or a combination thereof. The method 150 then ends at step 160.

The software enable matrix includes a plurality of elements, wherein each element maps or initializes and/or loads one software routine, according to one embodiment. By way of explanation and not limitation, according to a disclosed embodiment, the software enable matrix can include up to ninety-six (96) elements, such that a portion of the elements can initialize the following software routines: normal communication, General Motors (GM) autonomous reflash, Ford autonomous reflash, class two (2) bus arbitration tool, controller area network (CAN) bus arbitration tool, flight recorder, Nissan autonomous reflash, emulation tool, Hyundai autonomous reflash, the like, or a combination thereof.

According to one embodiment, the software routines on the hardware device 14 are stored in the memory device 15 that is in communication with the processor 16. According to an alternate embodiment, the processor 16 can include a memory device 15 that stores the software routines. Thus, when the encrypted software enable matrix is loaded onto the hardware device 14, the processor 16 executes enabled or initialized software routines, and bypasses or does not execute un-enabled or non-initialized software routines. The data for creating the software enable matrix includes an authorization for initializing the selected or purchased software routines, according to one embodiment. It should be appreciated by those skilled in the art, that the data for creating the software enable matrix can also include data for non-initializing software routines that were previously initialized.

According to an alternate embodiment, the hardware device 14 contains substantially all software routines. Thus, when the authorization code is authenticated, the software enable matrix includes data that is downloaded onto the hardware device 14 in order to modify non-initialized software routines, modify initialized software routines, or a combination thereof. The processor 16 executes software routines based on the software enable matrix, such that initialized software routines are executed and non-initialized software routines are bypassed or not executed.

The memory device 15 can be re-flashed, such that new software routines are being stored that can be initialized and executed by the processor 16. According to one embodiment, the additional or downloaded software routines can be initialized at the time of downloading, such that the additional software routines are executed by the processor 16 in order for the hardware device 14 to communicate with the external device 18. Alternatively, at least a portion of the additional software routines is non-initialized, such that the downloaded non-initialized software routines are not executed by the processor 16 until the non-initialized software routines are initialized at a later time.

According to a disclosed embodiment, the housing 20 includes a plurality of indicator lights to indicate the status of the software modification. For purposes of explanation and not limitation, the plurality of lights can include six (6) light emitting diodes (LEDs) 28, 30, 32, 34, 36, 38, wherein a first LED 28 and a third LED 32 turn on while the hardware device 14 is being programmed, such that the software routines are being modified. Additionally, a sixth LED 38 can flash while the memory device 15 is being erased, and a fifth LED 36 can flash when software routines are being saved on the memory device 15. According to other embodiments, other software initialization status indicators, such as audio sound (e.g., words) output from a speaker could be employed.

By way of explanation and not limitation, in operation, the system 10 can be used by a supplier, such that the supplier sells the system 10 to a manufacturer or servicer of external devices, such as, but not limited to, a manufacturer or servicer of vehicles, where only the desired software routines are initialized on the hardware device 14, according to one embodiment. Thus, the manufacturer can purchase the same system 10 from the supplier for multiple vehicle models, where the system has different software routines initialized for the different models, and the manufacturer does not have to purchase software routines, or the right to use software routines stored on the hardware device 14, that would otherwise not be used. Additionally, if non-initialized software routines included in the system 10 are later desired, the software routines can be initialized. Alternatively or additionally, new or additional software routines can be loaded onto the hardware device 14 that can be initialized at the time of loading or remain non-initialized.

Advantageously, a user can purchase the hardware device 14, such that the hardware device 14 includes initialized software routines for communication with the desired external device 18. Therefore, a user is not required to purchase all the available software routines, or the right to use all of the software routines stored on the hardware device 14, and thus, only purchases the ability to communicate with the desired external device 18 in the desired manner. Additionally, additional software routines corresponding to the external device 18 can be initialized at a later time by method 100, wherein the authorization code is unique to the hardware device 14. Further, the hardware device 14 can be re-flashed or additional software routines can be stored on the memory device 15, which were not initially on the hardware device 14.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A system for implementing software routines comprising:
a computer device that accesses data in an authorization database; and
a hardware device in communication with said computer device, wherein said hardware device comprises a memory device that stores at least one of an initialized software routine and a non-initialized software routine, and a processor that executes said at least one initialized software routine, wherein at least one of said initialized and non-initialized software routines are modified by the steps comprising:
generating an authorization code by said computer device, wherein said authorization code is unique to said hardware device;
loading said authorization code;
authenticating said authorization code;
creating a current software enable matrix based upon at least said authorization code;
communicating said current software enable matrix from said computer device to said hardware device;
overwriting a previous software enable matrix with said current software enable matrix; and
modifying said at least one of said initialized and non-initialized software routines based upon said current software enable matrix, such that at least one of said initialized software routine is modified to be non-initialized and said non-initialized software routine is initialized.

2. The system of claim 1, wherein said authorization code is based upon at least one of a purchase date of said hardware device, at least one of said initialized software routine and said non-initialized software routine, and an identification number relating to said hardware device.

3. The system of claim 1, wherein said hardware device contains substantially all available said initialized and non-initialized software routines and said step of modifying said at least one software routine comprises said current software enable matrix modifying said available software routines to initialize a predetermined portion of said available non-initialized software routines.

4. The system of claim 1, wherein said step of modifying said software routines comprises loading an additional software routine onto said hardware device, and said additional software routine is one of initialized and non-initialized.

5. The system of claim 1, wherein said modification of said initialized and non-initialized software routines further comprise the steps of encrypting said authorization code by said computer device, and decrypting said authorization code.

6. The system of claim 1, wherein said step of authenticating said authorization code comprises the step of comparing data embedded in said authorization code to corresponding data stored on said hardware device.

7. The system of claim 1 further comprising an external device in communication with said hardware device, wherein said hardware device executes at least a portion of said initialized software routines to communicate with said external device.

8. The system of claim 7, wherein said external device is in a vehicle.

9. A method of modifying software routines executed by a hardware device, said method comprising the steps of:
generating an authorization code, wherein said authorization code is unique to said hardware device;
loading said authorization code;
authenticating said authorization code;
creating a current software enable matrix based upon at least said authorization code;
communicating current software enable matrix;
overwriting a previous software enable matrix with said current software enable matrix; and
modifying at least one software routine based upon said current software enable matrix based upon said current software enable matrix, such that at least one of an initialized software routine of said at least one software routine stored on a hardware device is modified to be non-initialized and a non-initialized software routine of said at least one software routine stored on said hardware device is initialized.

10. The method of claim 9, wherein said authorization code is based upon at least one of a purchase date of said hardware device, at least one of said initialized software routine and said non-initialized software routine, and an identification number relating to said hardware device.

11. The method of claim 9, wherein said hardware device contains substantially all available said initialized and non-initialized software routines and said step of modifying said at least one software routine comprises said current software enable matrix modifying said available software routines to initialize a predetermined portion of said available non-initialized software routines.

12. The method of claim 9, wherein said step of modifying said software routines comprises loading an additional software routine onto said hardware device, and said additional software routine is one of initialized and non-initialized.

13. The method of claim 9, wherein said step of authenticating said authorization code comprises the step of comparing data embedded in said authorization code to corresponding data stored on said hardware device.

14. The method of claim 9 further comprising the step of encrypting said current enable matrix.

15. The method of claim 9 further comprising the steps of encrypting said authorization code prior to said step of loading said authorization code, and decrypting said authorization code after said step of loading said authorization code.

16. The method of claim 9 further comprising the step of executing at least one said initialized software routine by said hardware device to communicate with an external device.

17. A method of modifying software routines executed by a hardware device, said method comprising the steps of:
generating an authorization code, wherein said authorization code is unique to said hardware device such that said authorization code is based upon at least one of a purchase date of said hardware device, at least one software routine, and an identification number relating to said hardware device;
encrypting said authorization code;
loading said authorization code;
decrypting said authorization code;
authenticating said authorization code by comparing data embedded in said authorization code to corresponding data on said hardware device;
creating a current software enable matrix based upon at least said authorization code;
encrypting said current software enable matrix;
communicating said encrypted current software enable matrix;
overwriting a previous software enable matrix with said current software enable matrix; and
modifying at least one software routine based upon said current software enable matrix based upon said current software enable matrix, such that at least one of an initialized software routine of said at least one software routine stored on said hardware device is modified to be non-initialized and a non-initialized software routine of said at least one software routine stored on said hardware device is initialized.

18. The method of claim 17, wherein said hardware device contains substantially all available said initialized and non-initialized software routines and said step of modifying at least one software routine comprises said current software enable matrix modifying said available software routines to initialize a predetermined portion of said available non-initialized software routines.

19. The method of claim 17, wherein said step of modifying said software routines comprises loading an additional software routine onto said hardware device, and said additional software routine is one of initialized and non-initialized.

20. The method of claim 17 further comprising the step of executing at least one said initialized software routine by said hardware device to communicate with an external device.
